(19) United States
(12) Patent Application Publication
(10) Pub. No.: US 2026/0267415 A1
(43) Pub. Date: Sep. 10, 2026

(54) CONTACT-TYPE INPUT DEVICE

(71) Applicants: Yuki TAKAHASHI, Tokyo (JP); Kazutaka SAKAGUCHI, Tokyo (JP); Tomoya ISHITANI, Tokyo (JP)

(72) Inventors: Yuki TAKAHASHI, Tokyo (JP); Kazutaka SAKAGUCHI, Tokyo (JP); Tomoya ISHITANI, Tokyo (JP)

(73) Assignee: MINEBEA MITSUMI Inc., Nagano (JP)

(21) Appl. No.: 19/469,028

(22) PCT Filed: Apr. 16, 2024
(86) PCT No.: PCT/JP2024/015186

§ 371 Date: Sep. 25, 2025

(30) Foreign Application Priority Data
Apr. 28, 2023 (JP) 2023-074842

(51) Int. Cl. G06F 3/01; G06F 3/0354; G06F 3/038

(52) U.S. Cl. CPC G06F 3/016; G06F 3/03547; G06F 3/038

(57) ABSTRACT

Provided is a contact-type input device, in which an operation panel includes, on a front surface thereof, an operation part and a non-operation part. On a rear surface, a vibration actuator is disposed in a first section which corresponds to the operation part. A fixing member for fixing the operation panel is disposed, on the rear surface, in a second section which corresponds to a boundary between the operation part and the non-operation part.

### TECHNICAL FIELD

The present invention relates to a contact-type input apparatus.

### BACKGROUND ART

Configurations for imparting vibrations generated by an electromagnetic mechanism as a tactile sensation or an operational sensation (hereinafter, collectively referred to as a “tactile sensation”) to a finger pad of an operator or the like that comes into contact with an operation panel (hereinafter, simply also referred to as a “panel”) are known, for example, from PTLS 1 to 3.

The vibration actuator described in PTL 1 has a configuration in which a guide shaft is disposed perpendicular to a panel surface, a movable magnet and a fixed coil are disposed on the inside and the outside of the shaft in the radial direction of the shaft, and the movable magnet is reciprocally moved along the guide shaft. Therefore, a certain height is needed for the apparatus itself. The vibration actuator (vibration presentation apparatus) described in PTL 2 has a configuration in which a center yoke is disposed perpendicular to a panel surface, a movable coil and a fixed magnet are disposed on the inside and the outside of a shaft in the radial direction of the shaft, a support portion that supports a panel by surrounding the outer periphery of the panel with a vertical wall is disposed, and the movable coil is reciprocally moved along the center yoke inside the support portion. Therefore, a certain height is also needed for the apparatus itself. The vibration actuators described in PTLS 1 and 2 use a magnet (a permanent magnet), which poses problems in terms of manufacturing cost and ease of manufacturing.

The vibration actuator described in PTL 3 has a configuration in which plate shaped yokes are disposed to face both end portions of a core around which a coil is wound, and a flat plate shaped base part (to which the core assembly is fixed) and the plate shaped yokes are supported by a plate shaped elastic part. In the vibration actuator, the magnetic force generated at both end portions of the core by the energization of the coil attracts the yokes toward the core assembly, and the elastic force generated in the elastic part by the movement of the yokes causes the yokes to vibrate in the facing direction. As a result, the vibration actuator is thinned, and further, the vibration is output and the tactile sensation is imparted by the electromagnetic mechanism that does not use the magnet.

### CITATION LIST

### Patent Literature

PTL 1

Japanese Patent Application Laid-Open No. 2015-070729

PTL 2

Japanese Patent Application Laid-Open No. 2016-163854

PTL 3

Japanese Patent Application Laid-Open No. 2020-069447

### SUMMARY OF INVENTION

### Technical Problem

In a contact-type input apparatus that receives a contact operation input of an operator through an operation panel, a vibration source such as the vibration actuator is disposed on the back surface of an operation surface. The front surface serving as the operation surface does not necessarily function entirely as an operation portion that is configured to receive contact operation inputs from the operator, and there may be cases where there are an operation portion and a non-operation portion that is configured to not receive contact operation inputs from the operator. In such a case, it is desirable to achieve a satisfactory output intensity of the vibration to the operation portion while reducing an output intensity of the vibration to the non-operation portion.

An object of the present invention is to provide a contact-type input apparatus capable of providing a satisfactory vibration output to an operation portion and reducing vibration transmission to a non-operation portion.

### Solution to Problem

An aspect of the contact-type input apparatus according to the present invention includes the following: an operation panel; and a vibration actuator disposed on a back surface of the operation panel, in which
the contact-type input apparatus is configured to impart a tactile sensation to an operator by vibrating the vibration actuator in a surface orthogonal direction according to a contact operation on the operation panel,
the operation panel includes an operation portion and a non-operation portion on a front surface of the operation panel,
the vibration actuator is disposed in a first portion on the back surface, the first portion corresponding to the operation portion, and
a fixing tool that fixes the operation panel is disposed in a second portion on the back surface, the second portion corresponding to a boundary portion between the operation portion and the non-operation portion.

### Advantageous Effects of Invention

According to the present invention, it is possible to provide a contact-type input apparatus capable of providing a satisfactory vibration output to an operation portion and reducing vibration transmission to a non-operation portion.

### BRIEF DESCRIPTION OF DRAWINGS

FIGS. 1A and 1B are external views of a contact-type input apparatus according to Embodiment 1, as viewed from the front surface side and the back surface side, respectively;

FIG. 2 is an exploded perspective view of the contact-type input apparatus according to Embodiment 1, as viewed from the back surface side;

FIG. 3 is a diagram for describing a division of the front surface or the back surface in an operation panel of the contact-type input apparatus according to Embodiment 1;

FIG. 4 is a diagram for describing the disposition of position sensors in the operation panel of the contact-type input apparatus according to Embodiment 1;

FIG. 5 is a plan view of the contact-type input apparatus according to Embodiment 1, as viewed from the back surface side;

FIG. 6 is an external perspective view of a vibration actuator of the contact-type input apparatus according to Embodiment 1;

FIG. 7 is a plan view of the vibration actuator;

FIG. 8 is a bottom view of the vibration actuator;

FIG. 9 is a front view of the vibration actuator;

FIG. 10 is a right-side view of the vibration actuator;

FIG. 11 is a cross-sectional view taken along line A-A of FIG. 7;

FIG. 12 is a cross-sectional view taken along line B-B of FIG. 7;

FIG. 13 is an exploded perspective view of the vibration actuator;

FIG. 14 is an exploded perspective view illustrating the relationship between a movable part and an elastic support part in the vibration actuator;

FIG. 15 is an exploded perspective views illustrating the relationship between a movable part, an elastic support part, and a base part in the vibration actuator;

FIGS. 16A to 16C are diagrams for describing a behavior of the vibration actuator;

FIG. 17 is a perspective view of a variation of the vibration actuator;

FIG. 18 is an exploded perspective view of a variation of the vibration actuator;

FIG. 19 illustrates a circuit configuration of a controller of the vibration actuator;

FIG. 20 schematically illustrates a control system of the contact-type input apparatus according to Embodiment 1;

FIG. 21 is a plan view of a contact-type input apparatus according to Embodiment 2, as viewed from the back surface side;

FIG. 22 is a diagram for describing the disposition of position sensors and load sensors in an operation panel of a contact-type input apparatus according to Embodiment 3;

FIG. 23 schematically illustrates a control system of the contact-type input apparatus according to Embodiment 3;

FIG. 24 is a plan view of a contact-type input apparatus according to Embodiment 4, as viewed from the back surface side;

FIGS. 25A and 25B are exploded perspective views of the contact-type input apparatus according to Embodiment 4, as viewed from the back surface side and the front surface side, respectively;

FIG. 26 schematically illustrates a control system of the contact-type input apparatus according to Embodiment 4;

FIG. 27 is a plan view of a contact-type input apparatus according to Embodiment 5, as viewed from the back surface side; and

FIG. 28 is an exploded perspective view of the contact-type input apparatus according to Embodiment 5, as viewed from the front surface side.

### DESCRIPTION OF EMBODIMENTS

Hereinafter, an apparatus according to an embodiment of the present invention will be described with reference to the drawings.

In each of the embodiments to be described below, a Cartesian coordinate system (X, Y, Z) is used. The X direction, Y direction, and Z direction will be described as corresponding to the lateral direction, the longitudinal direction, and the surface orthogonal direction of the contact-type input apparatus, respectively. However, the length in the X direction and the length in the Y direction of the contact-type input apparatus may be the same. In a vibration actuator of the contact-type input apparatus, the X direction, the Y direction, and the Z direction are described as corresponding to a left-right direction, a front-rear direction, and an up-down direction, respectively, but it is needless to say that the correspondence relationship is different depending on an installation aspect of the vibration actuator. In addition, regarding the Z direction, in the present embodiment, the positive side in the Y direction (back side or back surface side) is a direction in which the operator presses when performing an operation, and the negative side in the Z direction (front side or front surface side) is a direction in which vibration feedback is applied to the operator.

The expression related to a shape used in the description of each embodiment is a convenient expression for promoting the understanding of the content, and the shape itself adopted in each embodiment is an example, and can be variously modified and adopted.

### Embodiment 1

### Overall Configuration of Contact-Type Input Apparatus 1

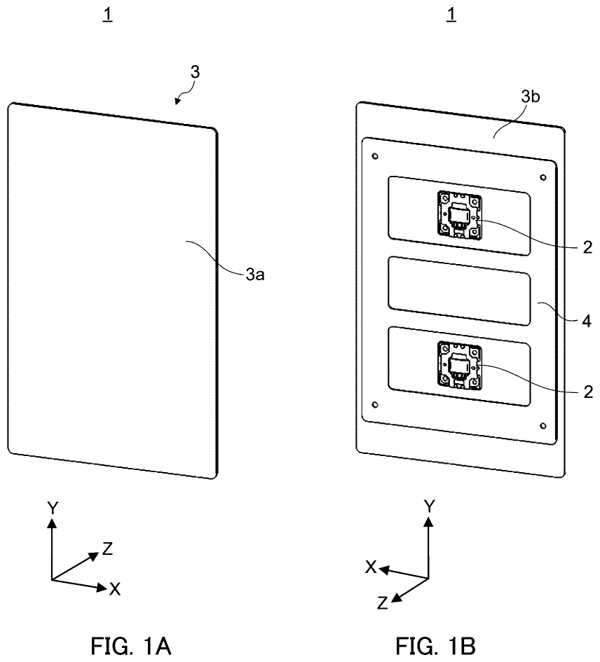

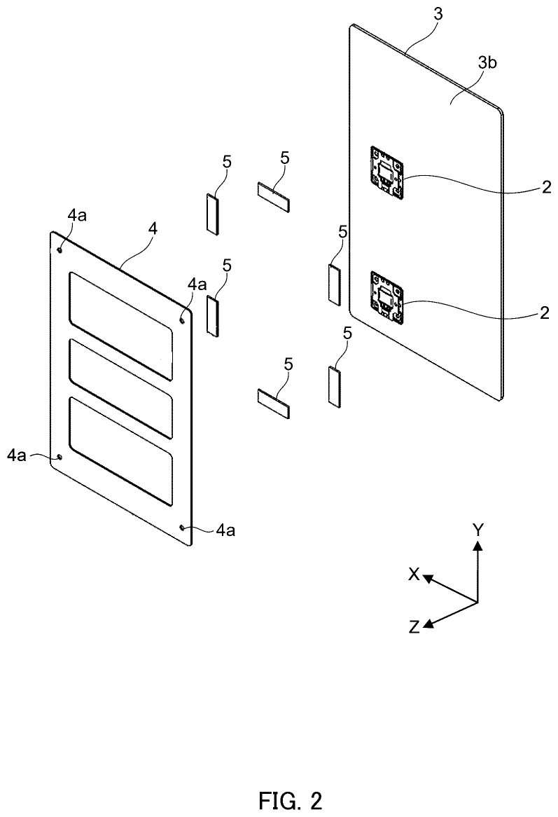

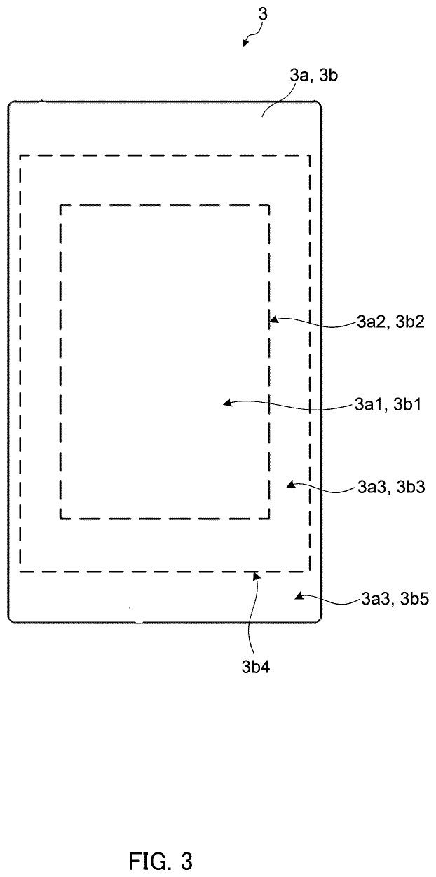

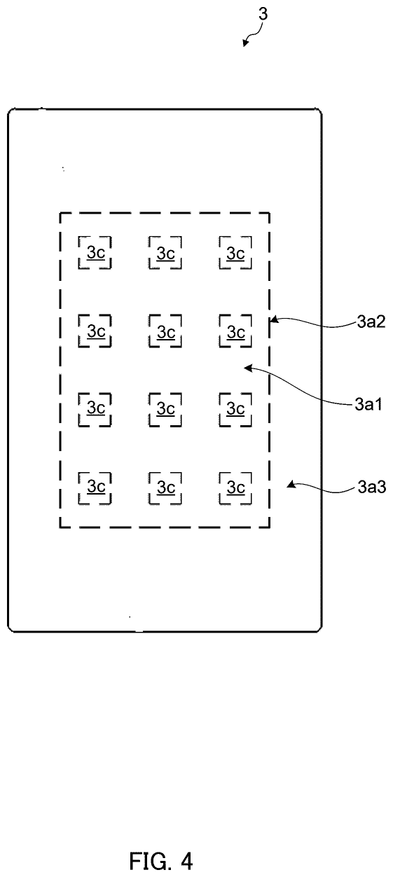

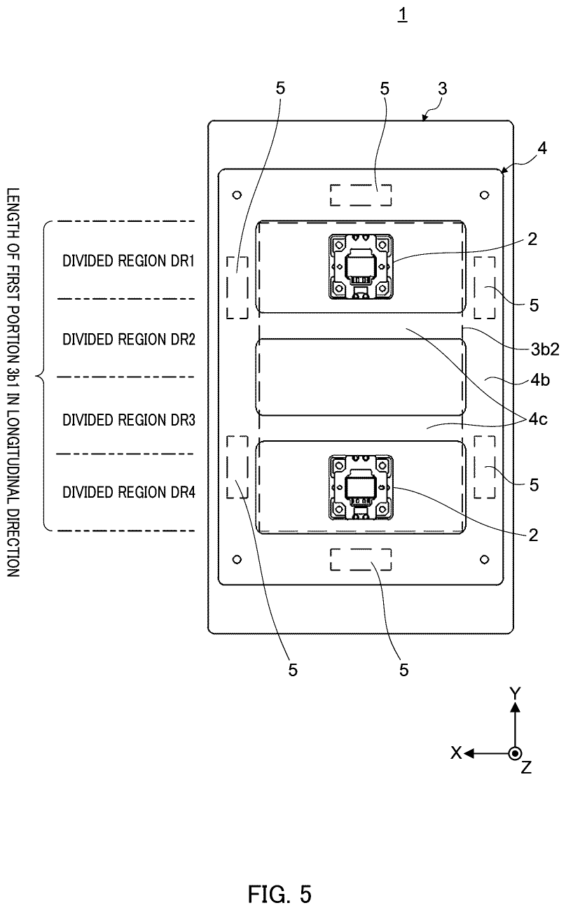

FIGS. 1A and 1B are external views of a contact-type input apparatus according to Embodiment 1, as viewed from the front surface side and the back surface side, respectively. FIG. 2 is an exploded perspective view of the contact-type input apparatus according to the present embodiment, as viewed from the back surface side. FIG. 3 is a diagram for describing a division of the front surface or the back surface in an operation panel of the contact-type input apparatus according to the present embodiment. FIG. 4 is a diagram for describing the disposition of position sensors in the operation panel of the contact-type input apparatus according to the present embodiment. FIG. 5 is a plan view of the contact-type input apparatus according to the present embodiment, as viewed from the back surface side.

A contact-type input apparatus (hereinafter, also simply referred to as an “input apparatus”) 1 according to the present embodiment includes a vibration actuator (hereinafter, also simply referred to as an “actuator”) 2 that is a vibration source of vibration to be fed back as a tactile sensation, an operation panel (hereinafter, also simply referred to as a “panel”) 3 to which actuator 2 is to be attached, frame 4 that exhibits a vibration transmission blocking function, and joining member 5 that joins panel 3 and frame 4.

Panel 3 includes, on front surface 3a thereof, operation portion 3a1 that is a region capable of receiving a contact operation input from an operator, and non-operation portion 3a3 that is a region positioned on an outer periphery of outer edge portion 3a2 of operation portion 3a1 and not capable of receiving the contact operation input from the operator. In the present embodiment, the exterior of front surface 3a of panel 3 has a seamless design, and outer edge portion 3a2 that is a boundary line between operation portion 3a1 and non-operation portion 3a3 is indistinguishable from the outside. However, the exterior of front surface 3a of panel 3 does not have to be seamless.

In back surface 3b of panel 3, a position range corresponding to operation portion 3a1 is first portion 3b1, and an annular position range surrounding the outer periphery of the boundary line (outer edge portion 3a2) between operation portion 3a1 and non-operation portion 3a3 is second portion 3b3. That is, second portion 3b3 is a portion located on back surface 3b and corresponding to the boundary portion between operation portion 3a1 and non-operation portion 3a3. Third portion 3b5 extends further outward from outer periphery of outer edge portion 3b4 of second portion 3b3. In back surface 3b, a position range corresponding to non-operation portion 3a3 is divided into second portion 3b3 and third portion 3b5.

When contact-type input apparatus 1 according to the present embodiment is applied to a track pad as a pointing device in, for example, a notebook computer, operation portion 3a1 of panel 3 functions as the track pad. In this case, non-operation portion 3a3, which is an exterior portion surrounding operation portion 3a1, typically functions as a palm rest. That is, non-operation portion 3a3 is a portion on which an operator places their hand to stabilize the position of their fingers for operation, and accordingly where the operator makes contact.

The type of device to which contact-type input apparatus 1 is applicable is not limited to the track pad, and may be another type of apparatus such as a touch pad or a touch panel as long as the apparatus has a planar operation portion capable of receiving a contact operation input, and a non-operation portion located on the same plane as the operation portion.

In addition, in the present embodiment, as illustrated in FIG. 4, a plurality of position sensors 3c are disposed in a two-dimensional array on front surface 3a of panel 3, and are capable of detecting which position in operation portion 3a1 a contact operation has been performed. The type of position sensor 3c is not particularly limited, but is, for example, a capacitive sensor. The plurality of position sensors 3c may be disposed at a high density so as to be capable of detecting a contact position with high resolution, or may be disposed to be separated from each other as illustrated in the drawing.

Actuator 2 is disposed in first portion 3b1 of back surface 3b of panel 3. Actuator 2 vibrates in a surface orthogonal direction that is orthogonal to a panel surface (front surface 3a and back surface 3b) according to the contact operation of the operator on panel 3, and applies the vibration from the back surface 3b side to operation portion 3a1 on the front surface 3a side, thereby imparting a tactile sensation to the operator. Although an internal configuration of actuator 2 will be described below, as actuator 2 is an electromagnetically driven type that generates vibrations in the surface orthogonal direction, actuator 2 can apply high-output vibrations to panel 3.

In the present embodiment, two actuators 2 are disposed in first portion 3b1. More specifically, two actuators 2 are disposed in two divided regions DR1 and DR4 located at both ends of first portion 3b1 in the longitudinal direction thereof (Y direction), out of four divided regions DR1, DR2, DR3, and DR4 obtained by dividing the length of first portion 3b1 in the longitudinal direction into four equal parts. That is, two actuators 2 are disposed inside first portion 3b1 corresponding to operation portion 3a1, but at positions relatively close to second portion 3b3 corresponding to non-operation portion 3a3. In second portion 3b3, panel 3 is fixed by frame 4 as will be described below and the vibration transmission is suppressed, and therefore it is more difficult to achieve a satisfactory output intensity of the vibration at an end portion than at a central portion in first portion 3b1 due to the influence of the vibration transmission suppression. However, in the present embodiment, actuators 2 are disposed at both end portions of first portion 3b1 in the longitudinal direction, and therefore satisfactorily high-output vibration can be achieved even at both end portions of first portion 3b1 in the longitudinal direction. That is, it is possible to provide a tactile sensation over a wide range while suppressing vibration transmission to non-operation portion 3a3, which would otherwise provide an unnecessary tactile sensation.

Frame 4 functions as a fixing tool that fixes panel 3. Frame 4 is a frame-shaped plate member having high rigidity, and is, for example, a member formed by punching out the central portion of a metal plate to form an annular shape. In the present embodiment, frame 4 is mounted on second portion 3b3 in back surface 3b of panel 3 by joining member 5 having pressure-sensitive adhesive properties, such as a double-sided tape. Joining member 5 may be, for example, a screw, and in this case, frame 4 may be attached to panel 3 by inserting the screw into through hole 4a (see FIG. 4) of frame 4 and screwing the screw into panel 3.

Frame 4 has a rectangular outer peripheral portion 4b and central portion 4c (two central portions 4c in the present embodiment) that extends to cross first portion 3b1 and bridges the two opposite sides of outer peripheral portion 4b, thereby providing satisfactory rigidity and mechanical strength to frame 4. Outer peripheral portion 4b is disposed in second portion 3b3 and has a shape that surrounds the entire periphery of first portion 3b1. This shape can prevent the vibration input from actuator 2 to first portion 3b1 from spreading and being transmitted to second portion 3b3 and third portion 3b5 over the entire periphery of first portion 3b1, thereby blocking the transmission of vibration from operation portion 3a1 to non-contact portion 3a3 in front surface 3a of panel 3.

### Configuration of Vibration Actuator 2

Hereinafter, a configuration of vibration actuator 2 will be described. In the description of the configuration of vibration actuator 2, the positive side in the Z direction is referred to as a “planar side” or an “upper side”, and the negative side in the Z direction is referred to as a “bottom surface side” or a “lower side”. In addition, in each component constituting vibration actuator 2, the surface on the “planar side” or the “upper side” is referred to as a “front surface” or an “upper surface”, and the surface on the “back surface side” or the “lower side” is referred to as a “back surface” or a “lower surface”.

### Overall Configuration of Vibration Actuator 2

Vibration actuator 2 is a thin vibration actuator in the shape of a flat plate or a thin plate. Assuming that the Z direction is the thickness direction, the vibration actuator is disposed to face the back surface side of an operation apparatus in the thickness direction and to be able to vibrate the operation apparatus.

Vibration actuator 2 is formed in a thin plate shape, and includes movable part 20, base part 30, and a plate-shaped elastic part 40 as an elastic support part (elastic body) that supports movable part 20 to be movable with respect to base part 30. Plate-shaped elastic part 40 serves as the elastic support part, but the shape of the elastic support part is not limited to a plate shape as long as the elastic support part supports movable part 20 so that the movable part can move with respect to base part 30. In addition, since base part 30 has a flat plate shape in the present embodiment, base part 30 is also referred to as a “base plate” in the following description, but base part 30 does not have to be in a plate shape and may be subjected to some bending processing. Movable part 20 also has a plate shape in the present embodiment, but does not have to be in a plate shape as long as movable part 20 is thin. Movable part 20, base part 30, and plate-shaped elastic part 40 are disposed in such a way that respective plate surfaces are along an XY plane, and as a result, an overall configuration of vibration actuator 2 is also of a thin plate shape along the XY plane.

Vibration actuator 2 can be connected to operation panel 3 configured to receive the contact operation input from an operator through one of movable part 20 and base part 30.

Vibration actuator 2 imparts vibrations as a tactile sensation to the operation apparatus (to which vibration actuator 2 is attached) as movable part 20 vibrates in the Z direction, specifically, by moving toward and away from base part 30.

### Movable Part 20

Movable part 20 is formed in a rectangular plate shape, and includes coil 22 and core 24, and weight portion 26. The coil is formed in a flat shape and is disposed so as to surround the central portion of core 24. Coil 22 is disposed on the outer periphery of the central portion of core 24 via an insulation material. The insulation material may be, for example, a coating material that is coated on core 24 and then cured, or may be configured as a bobbin-shaped insulation member and interposed between coil 22 and core 24. As the insulation material, for example, a resin material such as polybutylene terephthalate (PBT) can be used, thereby providing satisfactory electrical insulation between coil 22 and core 24.

Core (magnetic core) 24 is a magnetic body, and both end portions 24a and 24b thereof in the winding axis direction protrude from the wound coil 22, that is, both end portions 24a and 24b protrude from coil 22. In addition, core 24 includes spring connecting portions 241 and 242 provided at the tips of both end portions 24a and 24b of the core, respectively, and both end portions 24a and 24b are joined to the elastic support part. Core 24 is formed in a rectangular plate shape, and both end portions 24a and 24b each have a rectangular plate shape with a wide width and face base part 30 on the back surface side thereof. Weight portions 26 that extend on spring connecting portions 241 and 242 are attached to the front surfaces of both end portions 24a and 24b.

Weight portion 26 has a plate shape, and is preferably provided so as to correspond to the shape of core 24, for example, the width (length in the X direction) and the length in the depth direction (length in the Y direction). Weight portion 26 may have any weight, which can be adjusted, for example, by adjusting the length of weight portion 26 in the Y-direction, by adjusting the length of weight portion 26 in the Z-direction, by changing the material of weight portion 26, or the like. As described above, weight portion 26 can adjust the weight of movable part 20, and the natural frequency can be set by this adjustment. When the arrangement space in the thickness (Z direction) is restricted, the weight portion may have a shape such that the weight thereof increases in the XY direction.

Core 24 is magnetized by energization of coil 22, and functions as an electromagnet. Both end portions 24a and 24b serve as magnetic poles, generating a magnetic attraction force between the magnetic pole and a magnetic body closely located thereto, that is, base part 30. In other words, movable part 20 includes an electromagnet including core 24 and coil 22 wound around the central portion of core 24.

Due to energization of coil 22, both end portions 24a and 24b of core 24, particularly the back surfaces of both end portions 24a and 24b, serve as planar pole surfaces. Core 24 is preferably formed of a soft magnetic material such as a silicon steel plate, permalloy, or ferrite. Alternatively, core 24 may be constituted by electromagnetic stainless steel, a sintered material, a metal injection mold (MIM) material, a laminated steel sheet, an electrolytic galvanized steel sheet (SECC), or the like.

### Base Part 30

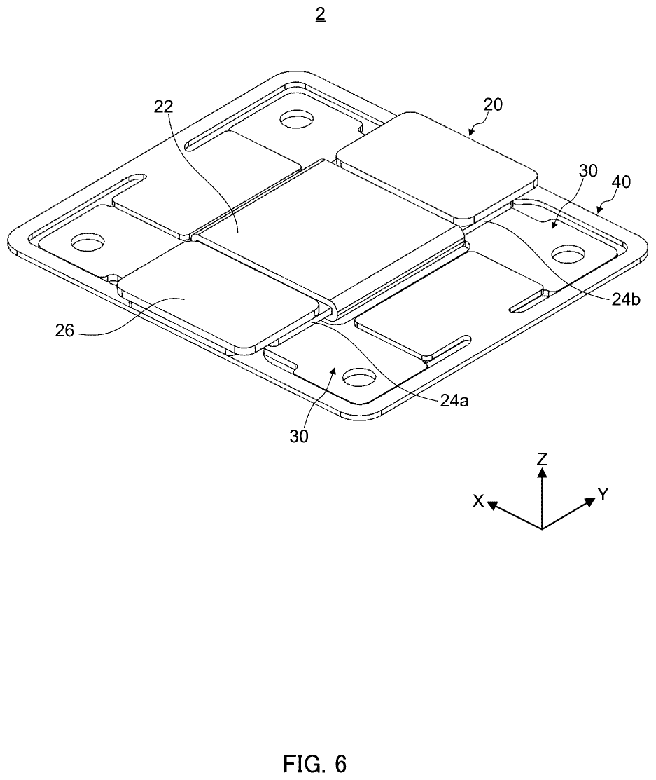

Base part 30 supports movable part 20 via plate-shaped elastic part 40 so that movable part 20 is movable in the approaching and separating direction relative to base part 30, that is, in the Z direction in FIG. 6. Base part 30 includes facing portions 32a and 32b that are magnetic bodies disposed to face both end portions 24a and 24b of core 24 in the facing direction—a direction intersecting with the winding axis direction of coil 22—with gap G between the end portion and the magnetic body. Base part 30 is a flat-shaped member having a predetermined thickness in the Z direction, and forms the bottom surface of vibration actuator 2.

Base part 30 includes base main body 31 that is a magnetic body. Base main body 31 is provided with facing portions (magnetic bodies) 32a and 32b (which are disposed to face both end portions 24a and 24b), spring connecting portions 34a and 34b (which are elastic member connecting portions), and fixing portion 36.

Base main body 31 includes opening portion 38 in the center thereof, and is formed in a square frame shape in a plan view. Opening portion 38 is a space into which the lower portion of coil 22 is inserted, and has a shape corresponding to the outer shape of coil 22, for example, a square shape.

In base main body 31, facing portions 32a and 32b are respectively formed on two side portions 311 that face each other and are spaced apart from each other. Between side portions 311, spring fixing portions 34a and 34b are respectively formed on the other two side portions 312 that face each other and are spaced apart from each other. Facing portions 32a and 32b and spring fixing portions 34a and 34b are formed on the front surface of base main body 31, that is, on the surface on the side of the movable part.

Each of the two side portions 311 and the other two side portions 312 is a planar body, and notches 311a and 312a are formed at central portions of four outer edge portions constituting the outer peripheral portion of base main body 31. Notches 311a and 312a are each provided to secure a part of the deformation region for a disposed plate-shaped elastic part 40.

Facing portions (facing surfaces) 32a and 32b are a part of base part 30, and constitute magnetic bodies which are disposed to respectively face both end portions 24a and 24b of core 24 in the facing direction (for example, the Z direction) which intersects with the winding axis direction of coil 22, with gap G between the end portion and the magnetic body. Facing portions 32a and 32b are attracted to both end portions 24a and 24b by a magnetic attraction force generated between the facing portion and the back surface of both end portions 24a and 24b due to energization of coil 22. Facing portions 32a and 32b are respectively formed in, for example, central portions of two side portions 311 and are disposed at the positions with opening portion 38 between the facing portions in the Y direction.

Facing portions 32a and 32b are surfaces that entirely face the back surfaces of both end portions 24a and 24b, and therefore allow magnetic flux to flow efficiently between the facing portion and the back surface of both end portions 24a and 24b. Facing portions 32a and 32b are formed of a ferromagnetic body such as iron (Fe), cobalt (Co), nickel (Ni), gadolinium (Gd), or the like as a part of base main body 31. Facing portions 32a and 32b, together with spring connecting portions 34a and 34b and fixing portions 36, are formed of particularly a metal material (for example, iron) such as iron, cobalt, nickel, or the like as base main body 31.

Both end portions 24a and 24b are disposed to be spaced apart from each other at a location above (in Z direction) facing portions 32a and 32b. Spring connecting portions 34a and 34b (two of them are symmetrical with respect to the center in the X direction, and each of them is symmetrical with respect to the center in the Y direction) are disposed in such a way that opening portion 38 is interposed therebetween in the X direction, and are joined to the other end portion of plate-shaped elastic part 40 on the front surface side of base part 30.

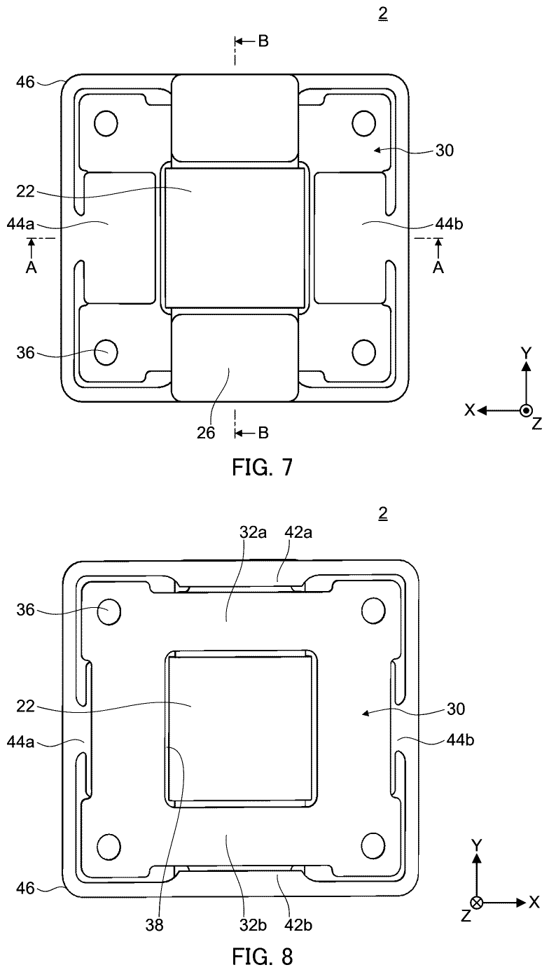

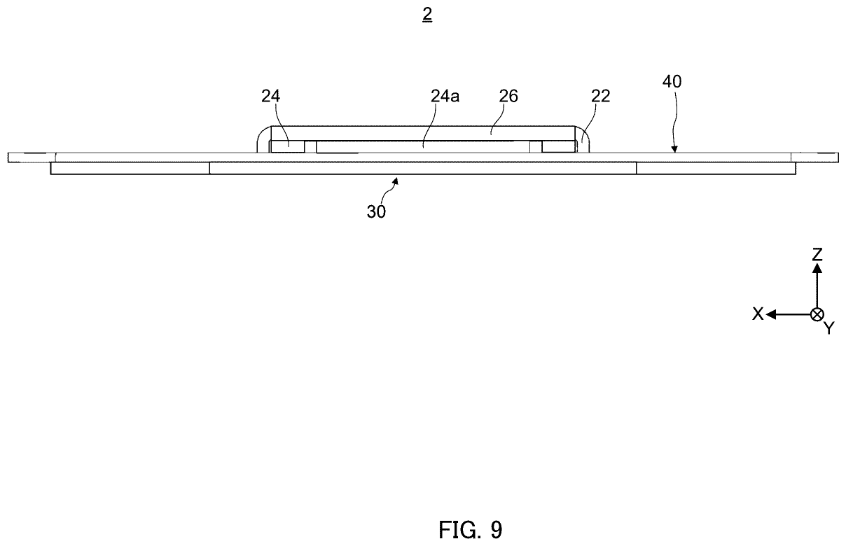

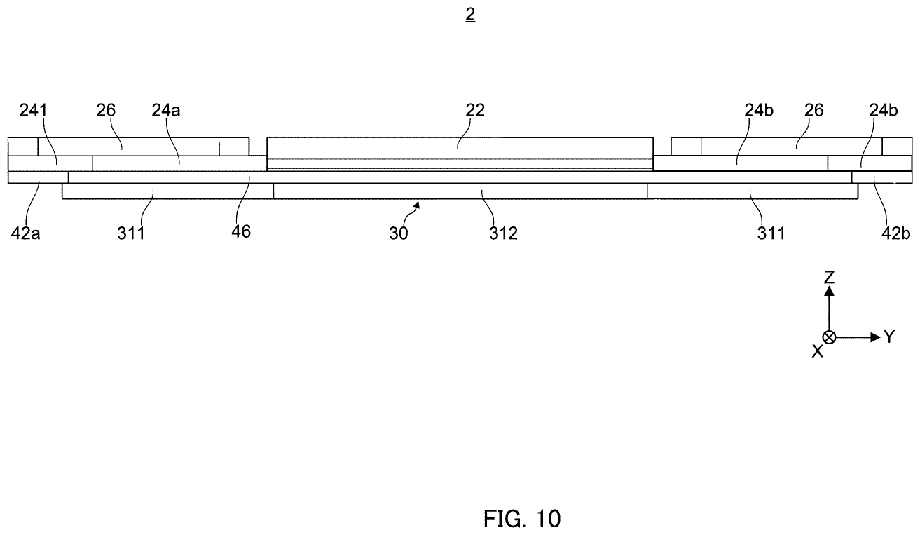

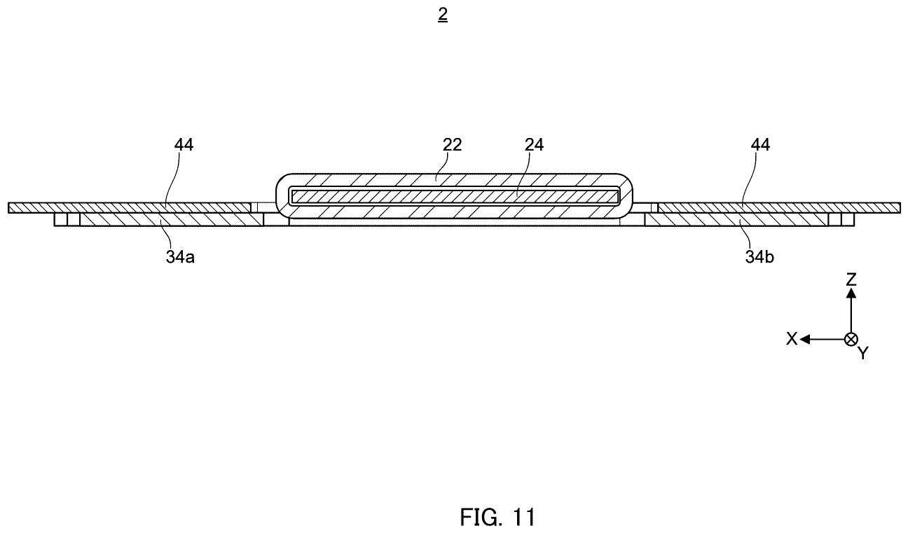

Fixing portion 36 fixes base part 30. Fixing portion 36 is, for example, a fastening hole that is fastened via a fastening member to an operating device (panel 3) that an operator touches and operates (see FIG. 7 and FIG. 8).

Fixing portions 36 are formed at four corners of base part 30, and can reliably fasten and fix base part 30 to a fixing target. Although fixing portions 36 are formed at four corners, any number of fixing portions 36 can be provided as long as base part 30 can be fixed to the fixing target.

As described above, base part 30 is flat plate shaped such that the plate surface thereof is disposed along the XY plane parallel to operation panel 3. Base part 30 includes opening portion 38 that allows the electromagnet of movable part 20 to move relative to the magnetic body of base part 30 while coil 22 is disposed inside the opening portion during vibration. With this configuration, a part of the thickness that is increased by coil 22 in movable part 20 can be absorbed by opening portion 38 of base part 30, and therefore, a thin configuration of the entire vibration actuator 2 can be achieved, and the configuration can also contribute to a reduction in thickness of the entire contact-type input apparatus 1 equipped with vibration actuator 2.

### Plate-Shaped Elastic Part 40

Plate-shaped elastic part 40 is a plate-shaped member, specifically, a plate spring that elastically deforms, and supports movable part 20 to be movable with respect to base part 30. Plate-shaped elastic part 40 is formed in a thin frame shape having a predetermined thickness (thickness in the Z direction), and is disposed between base part 30 and movable part 20 in a layered manner in the thickness direction (Z direction).

Plate-shaped elastic part 40 is connected to both movable part 20 and base part 30. In addition, plate-shaped elastic part 40 has the following configuration: plate-shaped elastic part 40 is formed in a rectangular frame shape surrounding base part 30; movable part 20 is joined to two side portions 461 parallel to each other; and base part 30 is joined to the other two side portions 462 facing each other and located adjacent to the two side portions 461. In other words, plate-shaped elastic body 40 supports the electromagnet of movable part 20 on one pair of opposite sides and is connected to base part 30, which is a magnetic body, on the other pair of opposite sides. As a result, plate-shaped elastic part 40 supports movable part 20 in a symmetrically balanced manner in the directions (X direction and Y direction) perpendicular to the facing direction (vibration direction) with respect to base part 30. Since plate-shaped elastic part 40 is a rectangular frame body (here, a thin frame-shaped body), the number of components can be reduced, the overall shape can be made thinner, and further, the component can be manufactured without bending processing or the like. Further, since plate-shaped elastic body 40 is a frame body, the other component can be disposed in the frame body so as not to interfere with the other component. In addition, plate-shaped elastic part 40 can determine an amount of displacement of movable part 20 and a natural frequency by setting a spring constant.

Plate-shaped elastic part 40 includes movable part-side fixing portions 42a and 42b, base part-side fixing portions 44a and 44b, and planar elastic main body 46 including arms that connect movable part-side fixing portions 42a and 42b to base part-side fixing portions 44a and 44b and elastically deform.

Elastic main body 46 connects movable part-side fixing portions 42a and 42b to base part-side fixing portions 44a and 44b in a manner such that elastic main body 46 is elastically deformable in the Z direction.

Elastic main body 46 includes deformable arm portions that connect movable part-side fixing portions 42a and 42b to base part-side fixing portions 44a and 44b. The arm portions are each formed, for example, in a substantially L shape and thus are in a frame shape that surrounds base part 30 in a plan view, and each is deformable in the Z direction on the outer peripheral side of base part 30.

In elastic main body 46, two parallel side portions 461 are each formed by one side of an L-shaped arm, which is linearly connected to corresponding one of movable part-side fixing portions 42a and 42b. In addition, in elastic main body 46, base part-side fixing portions 44a and 44b are formed on the other two side portions 462 (which are adjacent to the two side portions 461) in such a way that base part-side fixing portions 44a and 44b protrude inward.

In plate-shaped elastic part 40, elastic main body 46, movable part-side fixing portions 42a and 42b, and base part-side fixing portions 44a and 44b are disposed on the same plane.

Movable part-side fixing portions 42a and 42b are planar and are fixed to movable part 20. Movable part-side fixing portions 42a and 42b are provided in central portions of a pair of side portions 311 disposed on the outside of base part 30 in a plan view of elastic main body 46. Movable part-side fixing portions 42a and 42b are fixed, on the front surface thereof, to spring connecting portions 241 and 242 of core 24 by surface contact on the back surface side of spring connecting portions. Movable part-side fixing portions 42a and 42b are provided symmetrically with respect to the center in the X direction or the center in the Y direction in the respective directions. Base part-side fixing portions 44a and 44b are planar and are fixed to base part 30.

In order to have satisfactory elasticity, plate-shaped elastic part 40 includes arms of elastic main body 46, and the arms may have any shape as long as the arms can connect movable part-side fixing portions 42a and 42b and base part-side fixing portions 44a and 44b in a displaceable manner in the Z direction. In addition, elastic main body 46 may have any shape as long as elastic body portion 46 is formed in such a way that the elastic body portion deforms in a balanced manner for moving movable part 20 in the Z direction (vibration application direction) while movable part 20 is positioned on the XY plane.

Plate-shaped elastic part 40 supports movable part 20 in such a way that the back surfaces of the both end portions of movable part 20 face facing portions 32a and 32b of base part 30 with gap G therebetween in the vibration direction (Z direction), which is the vertical direction. Plate-shaped elastic part 40 forms gap G by its thickness (length in the Z direction).

Plate-shaped elastic part 40 is deformed between the upper surface of core 24 or coil 22 and the bottom surface of base part 30. As described above, plate-shaped elastic part 40 is formed in a rectangular frame shape, and movable part-side fixing portions 42a and 42b and base part-side fixing portions 44a and 44b are disposed in central portions of respective side portions forming the rectangular frame. When movable part 20 is driven, movable part-side fixing portions 42a and 42b are displaced with respect to base part-side fixing portions 44a and 44b.

In elastic main body 46, movable part 20 is supported on both sides by arms that has a L-shape and connect movable part-side fixing portions 42a and 42b with base part-side fixing portions 44a and 44b. Accordingly, this makes it possible to distribute stress during elastic deformation, and movable part 20 can be moved in the vibration direction (Z direction) without tilting relative to the base part 30, thereby improving the reliability and stability of the vibration state.

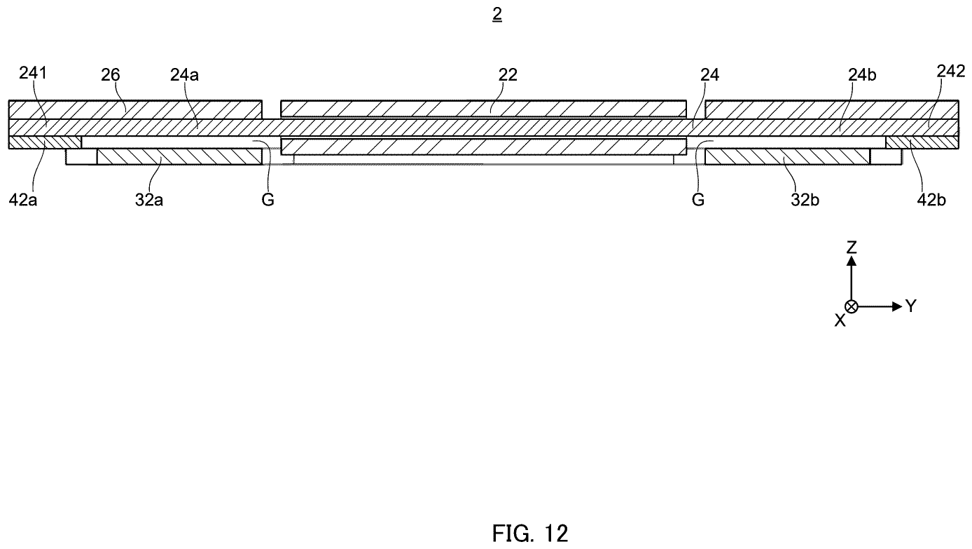

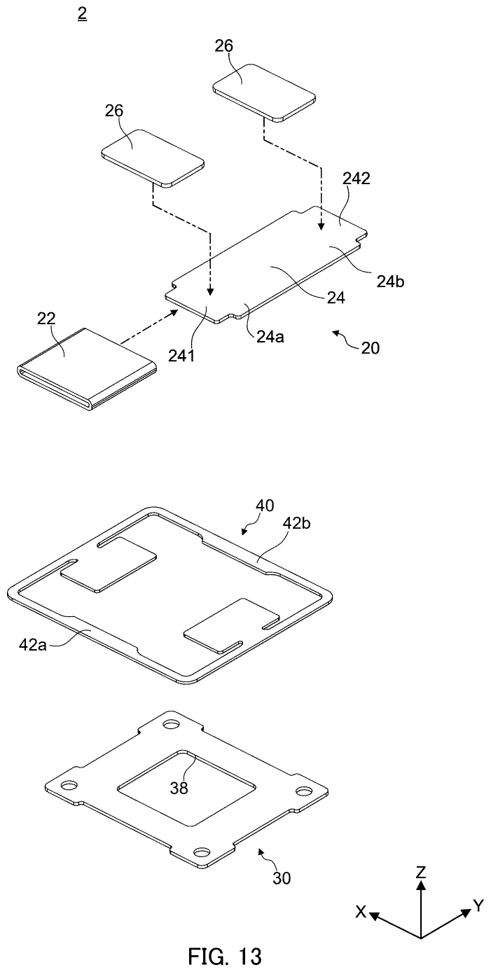

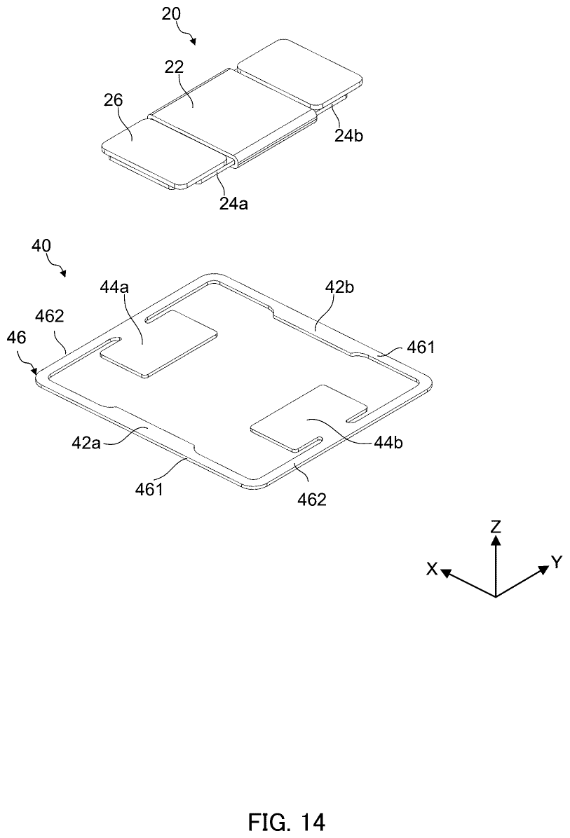

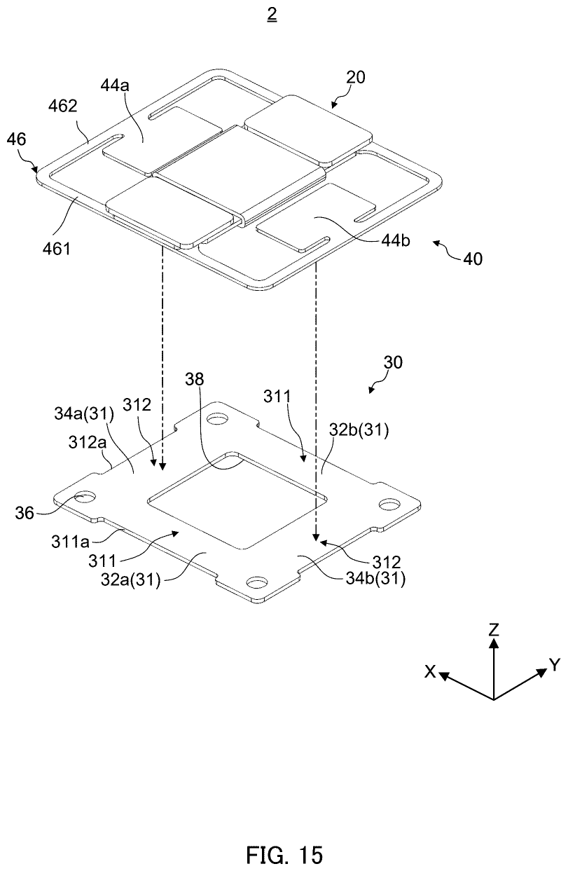

Base part 30, movable part 20 (particularly, core 24, which is magnetized during energization of coil 22 to function as an electromagnet), and plate-shaped elastic part 40 are flat plate shaped such that respective plate surfaces thereof are disposed to be parallel to operation panel 3. When one of core 24 or base part 30 is at a neutral position in the surface orthogonal direction, the entire plate-shaped elastic part 40 is located in gap G between base part 30 and core 24 in the surface orthogonal direction (see FIG. 12 and the like). With this configuration, while achieving a satisfactory stroke of movable part 20 in the surface orthogonal direction, base part 30, movable part 20, and plate-shaped elastic part 40, which are stacked one on the other, do not occupy a large area in the surface orthogonal direction, so that a thin configuration of the entire vibration actuator 2 can be achieved, and the configuration can also contribute to a reduction in thickness of the entire contact-type input apparatus 1 equipped with vibration actuator 2.

### Magnetic Circuit of Vibration Actuator 2

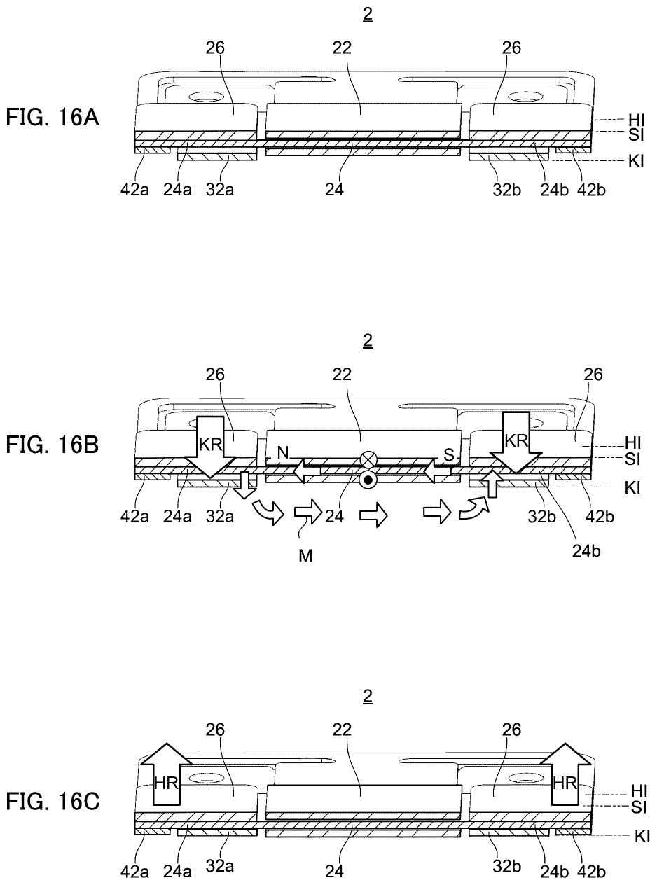

FIGS. 16A to 16C are diagrams for describing a behavior of the vibration actuator. FIGS. 16A to 16C are perspective views of vibration actuator 2 illustrating the portion cut along line B-B of FIG. 7, and a magnetic circuit has a magnetic flux flow M in the portion not illustrated, similar to that in the illustrated portion.

FIG. 16A illustrates a stationary state (positioned at a stationary position SI) of vibration actuator 2. When a current flows through coil 22 of vibration actuator 2 illustrated in FIG. 16A, core 24 is excited to generate a magnetic field, and both end portions 24a and 24b of core 24 become magnetic poles. For example, in FIG. 16B, in core 24, one end portion 24a is an N pole and the other end portion 24b is an S pole. In this manner, the magnetic circuit illustrated by the magnetic flux flow M is formed between core 24 and facing portions 32a and 32b of base part 30. The magnetic flux flow M in the magnetic circuit described above flows from one end portion 24a to facing portion 32a facing one end portion 24a, from facing portion 32a to facing portion 32b, and from facing portion 32b to the other end portion 24b of core 24, passes through core 24, and is emitted again from one end portion 24a.

Thus, both end portions 24a and 24b of core 24 generate magnetic attraction force KR based on the principle of the electromagnetic solenoid. In this manner, both of both end portions 24a and 24b are attracted to both of facing portions 32a and 32b of base part 30. Base part 30 is fixed to a housing or the like via fixing portion 36, and therefore both end portions 24a, 24b are attracted to and adsorbed to facing portions 32a, 32b. That is, plate-shaped elastic part 40 is deformed, and movable part 20 is attracted toward the base part 30 side. Movable part 20 is disposed close to the position (KI) side where base part 30 is fixed.

Next, when the energization of coil 22 is released, the magnetic field disappears, as illustrated in FIG. 16C, the magnetic attraction force KR of movable part 20 disappears, and a biasing force of plate-shaped elastic part 40 (having been deformed toward base part 30 side) is released. That is, reaction force HR of the spring as plate-shaped elastic part 40 is generated, and movable part 20 moves to the original position (position SI in a non-driven stationary state, which is a reference position) by reaction force HR of plate-shaped elastic part 40 (i.e., moves in the positive side in the Z direction, which is the direction opposite to the attraction direction of magnetic attraction force KR). At this time, reaction force HR causes movable part 20 to move to position HI where movable part 20 is displaced from stationary position SI where the movable part is in a stationary state in a direction away from base part 30, thereby generating strong vibration.

This vibration repeats as a free vibration while attenuating as the biasing force attenuates. Alternatively, coil 22 may be energized and deenergized repeatedly to cause movable part 20 to reciprocate in the Z direction, thereby generating vibration. In vibration actuator 2 as described above, movable part 20, which is supported in a state where the movable part is suspended from base part 30 by the plate-shaped elastic part 40, is mechanically displaced when electricity is applied due to the magnetic attraction force generated between the electromagnet and facing portions 32a and 32b (which are magnetic bodies), and then movable part 20 vibrates freely.

As described above, vibration actuator 2 generates the magnetic attraction force between core 24 and the facing portions (magnetic bodies) 32a and 32b by energizing coil 22, and causes movable part 20 to move toward base part 30 side. This movement generates vibration of movable part 20 by the (biasing force) elastic force generated in plate-shaped elastic part 40, and imparts the tactile sensation to the operator.

In vibration actuator 2, core 24 around which coil 22 is wound is supported by plate-shaped elastic part 40 to be movable in the Z direction with respect to base part 30 while coil 22 is inserted through opening portion 38 of base part 30. Vibration actuator 2 can be configured in such a way that the height thereof is the height of a stack of only thin plate-shaped core 24, a portion of coil 22 on core 24, plate-shaped elastic part 40, and base part 30. As a result, vibration actuator 2 can be configured in a thin plate shape, and a reduction in the disposition space can be realized. Further, this configuration is thinner than a configuration in which members that generate magnetism and drive a movable part in the Z direction are stacked in the Z direction, such as a configuration in which a coil and a magnet are disposed to face each other in the Z direction.

Further, plate-shaped core 24 is disposed to face vertically to facing portions 32a and 32b of base part 30, and movable part 20 is held so as to be vertically movable (in the vibration direction) through plate-shaped elastic part 40, which is a plate spring disposed between core 24 and base part 30. Therefore, core 24 is supported so as to be able to vibrate with respect to base part 30 with a space corresponding to the thickness of plate-shaped elastic part 40 is secured as a gap for the amplitude.

Base part 30 is in the form of a plate provided with opening portion 38 (opening) through which coil 22 is inserted in such a way that coil 22 is movable in the facing direction. In base part 30, fixing portion 36 for fixing base part 30 to operation panel 3 (which is configured to receive the contact operation input from an operator) is provided around opening portion 38. Plate-shaped elastic part 40 extends outside fixing portion 36 so as to surround base part 30. Thus, plate-shaped elastic part 40 can be elastically deformed without interfering with the fixing of base part 30, and further, a satisfactory stroke for the elastic deformation can be obtained.

In addition, in vibration actuator 2, all the components such as base part 30, plate-shaped elastic part 40, movable part 20, and the weight portion 26 are assembled in the Z direction, that is, in the thickness direction, and therefore, the vibration actuator can be easily assembled, and a vibration actuator that is stable and is less likely to be affected by a variation during assembly can be manufactured.

In addition, vibration actuator 2 has a configuration in which a satisfactory distance between core 24 and base part 30 is achieved by the thickness of plate-shaped elastic part 40. Thus, it is not necessary to provide another member in order to form a distance between core 24 and base part 30, the number of components can be reduced more, and further, it is possible to achieve size reduction, simplification of assembly, and cost reduction.

Further, plate-shaped elastic part 40 is a plate spring with a high manufacturing precision of thickness, the gap between core 24 and base part 30 (specifically facing portions 32a and 32b) is kept from varying, ensuring a stable gap. Since core 24 has a configuration in which the front surfaces of both end portions 24a and 24b thereof are exposed, the weight on the side of movable part 20 can be easily increase by using the space on the front surfaces.

Furthermore, vibrations are generated by linearly moving movable part 20 back and forth without using a magnet, and therefore, it is possible to achieve a reduction in cost as compared to the configuration using a magnet. Further, the number of components can be reduced, thereby achieving easy manufacturing.

Vibration actuator 2 is easy to assemble and can be made thin, allowing it to be disposed in a space-saving manner and vibrate appropriately. In addition, vibration actuator 2 can be made thinner and smaller, and can impart a suitable tactile sensation corresponding to a pressing operation of the operator on operation panel 3.

Regarding the use of current pulses to generate a resonance phenomenon in a vibration actuator to drive a movable part, the driving principle is described in, for example, PTL 3 with reference to a motion equation and a circuit equation. The drive principle can be applied to the present embodiment.

### Variation of Configuration of Vibration Actuator 2

The configuration of vibration actuator 2 is not limited to the above-described configuration, and various changes can be made to implement the configuration. Here, one variation of the configuration of vibration actuator 2 will be described.

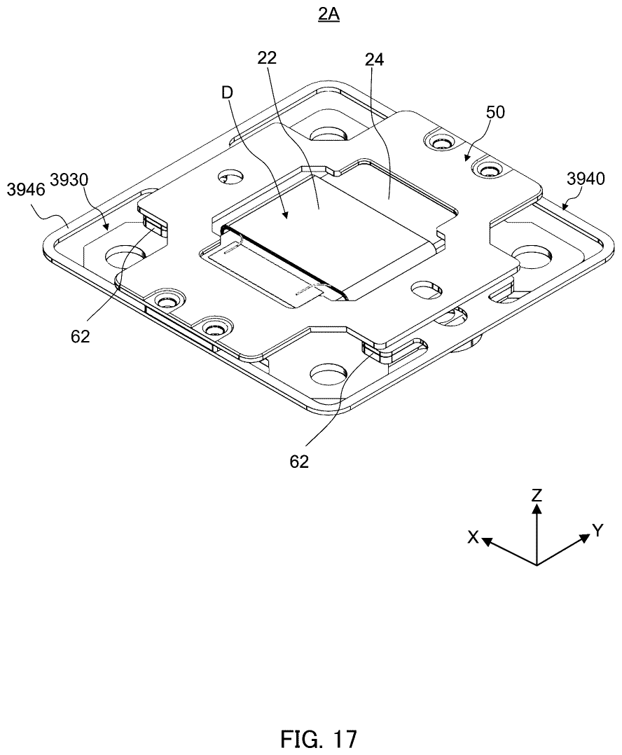

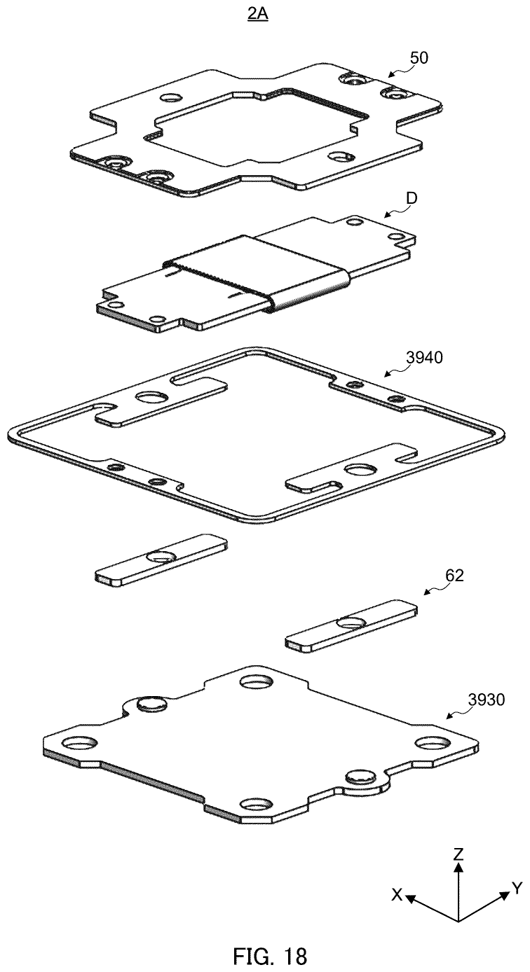

FIGS. 17 and 18 are perspective views and exploded perspective views of a variation of the vibration actuator.

In vibration actuator 2A described as an example here, base plate 3930 that is base part 30 is not provided with an opening. Base plate 3930 is a base plate having a high magnetic permeability and a shape without an opening portion in a configuration of base part 30 (see FIG. 8). Electromagnet D including coil 22 in the central portion of plate-shaped core 24 is disposed on base plate 3930.

Further, elastic body 3940—a frame body surrounding base plate 3930—is connected to base plate 3930 while supporting plate-shaped core 24. In this configuration, electromagnet D of movable part 20 vibrates in the vertical direction with respect to the plate surface of core 24 due to the magnetic force generated by energization of coil 22. In this case, the distance between coil 22 and base plate 30 can be adjusted by installing a spacer 62 illustrated in FIG. 53. Spacer 62 is interposed between base plate 3930 and the plate-side connecting portion of elastic body 3940.

### Drive Circuit of Vibration Actuator 2

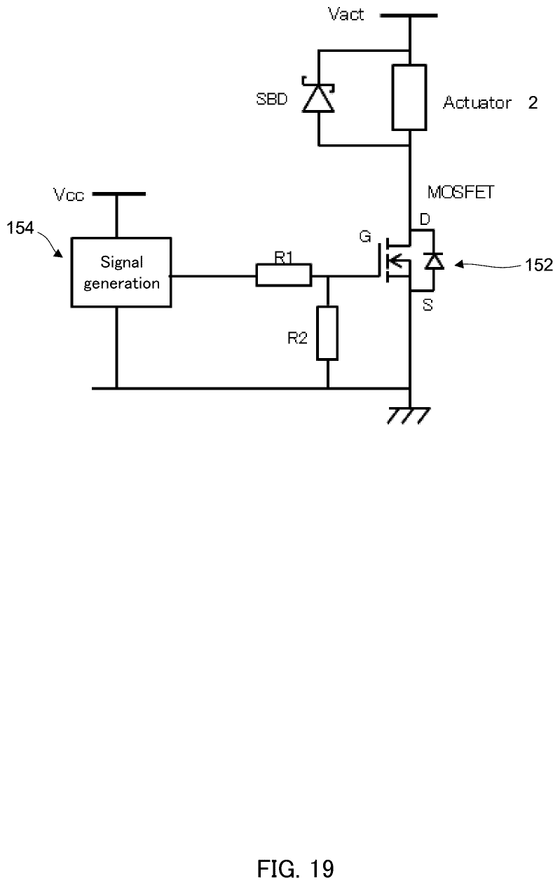

FIG. 19 illustrates a circuit configuration of a controller of the vibration actuator according to Embodiment 1.

The drive circuit illustrated in FIG. 19 is included in the controller of vibration actuator 2. The drive circuit includes switching element 152 as a current pulse supply unit configured by a metal-oxide-semiconductor field-effect transistor (MOSFET), a signal generation part (Signal generation) 154 as a voltage pulse application unit, resistors R1 and R2, and a Schottky barrier diode (SBD). The drive circuit is an example of a specific configuration of actuator driver 174 to be described below.

Signal generation part 154 connected to power supply voltage Vcc is connected to a gate of switching element 152. Switching element 152 is a discharge switching switch. Switching element 152 is connected to vibration actuator 100 (referred to as [Actuator] in FIG. 19), particularly, coil 22 of vibration actuator 2. The voltage is applied to vibration actuator 2 from power supply unit Vact. Therefore, switching element 152 is turned on and off by the gate voltage control of signal generation part 154, the current flows when switching element 152 is turned on, and coil 22 is energized in vibration actuator 2.

The controller may include the following: a processing device configured by a central processing unit (CPU) or the like that controls an entirety of the contact-type input apparatus 1 on which vibration actuator 2 is mounted; a main storage device configured by a random access memory (RAM) or the like that operates as a work area of the processing device; and an auxiliary storage device configured by a non-volatile memory such as a flash memory or a hard disk that stores an operation program of the processing device. A configuration including a processing device, a main storage device, and an auxiliary storage device is an example of a specific configuration of microcomputer 173 to be described below. The processing device reads various control programs, various data associated with the programs, and the like (hereinafter, the various control programs, various data, and the like are collectively referred to as “programs and the like”) from the auxiliary storage device and stores the programs and the like in the main storage device, executes the control program while using the data and the like, thereby realizing various functions of the vibration presentation apparatus. For example, the data may include pulse waveform data of various patterns that represent a plurality of different vibration damping periods, a plurality of different vibration intensities, or the like. The various control programs may include the following: a program that read the pulse waveform data for generating an actuator drive signal that generates the vibration corresponding to the input information when the information indicating the contact operation of the operator is input, and generate the actuator drive signal in accordance with the read pulse waveform data.

The auxiliary storage device may be a storage medium that can be attached to and detached from the vibration presentation apparatus. The controller may be configured to communicate with the outside, and the programs and the like may be downloaded from the outside to the controller (namely, main storage device or auxiliary storage device of the controller) via a communication network.

The main storage device and the auxiliary storage device are examples of a non-transitory computer-readable storage medium.

### Control System of Contact-Type Input Apparatus 1

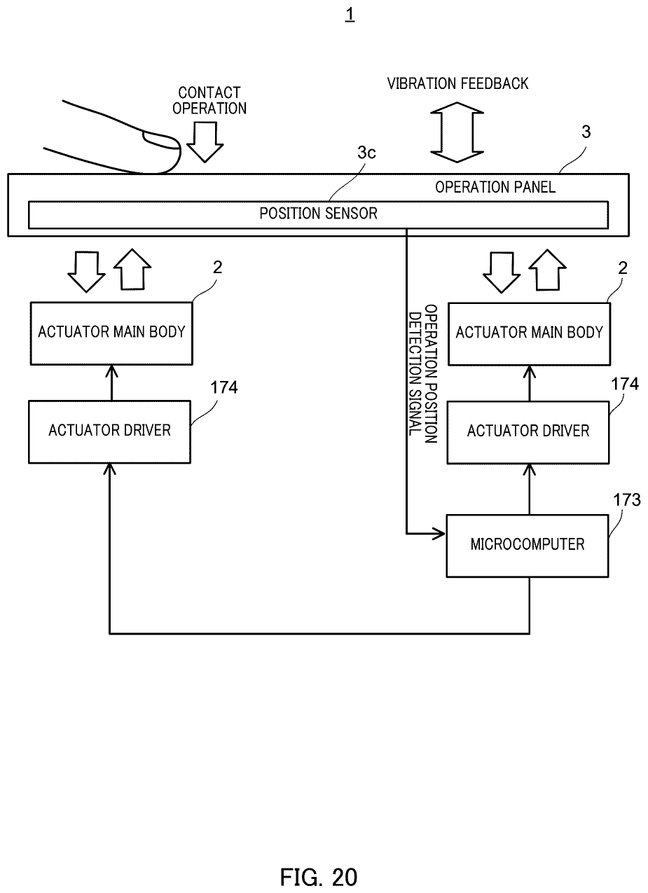

FIG. 20 schematically illustrates a control system of contact-type input apparatus 1.

The control system of contact-type input apparatus 1 illustrated in FIG. 20 includes two actuators 2, operation panel 3, a microcomputer 173, and two actuator drivers 174. In each vibration actuator 2, coil 22 of movable part 20 is functionally incorporated into the control system.

Operation panel 3 includes position sensor 3c that receives a contact operation from an operator on operation panel 3 and outputs a signal (operation position detection signal) indicating the contact position of the contact operation. Position sensor 3c outputs the operation position detection signal to microcomputer 173.

Microcomputer 173 controls one or both of actuator drivers 174 in such a way that vibration occurs at a position corresponding to the contact operation based on the operation position detection signal. Actuator driver 174 controlled by microcomputer 173 supplies a drive current as an actuator drive signal to coil 22 of the corresponding actuator 2.

Actuator 2 that has received the drive current from actuator driver 174 transmits vibration to operation panel 3 to vibrate operation panel 3, thereby imparting a tactile sensation to the operator who has operated operation panel 3. As described above, by energizing coil 22 of an appropriate actuator 2 according to the position detected by position sensor 3c and applying vibration to operation panel 3 at an appropriate position, a realistic tactile sensation such as a feel of a switch can be realized.

### Summary of Embodiment 1

As described above, according to the present embodiment, contact-type input apparatus 1 is a contact-type input apparatus including operation panel 3 and vibration actuator 2 disposed on back surface 3b of operation panel 3. The contact-type input apparatus 1 is configured to impart a tactile sensation to an operator by vibrating vibration actuator 2 in the surface orthogonal direction according to the contact operation on operation panel 3. In such contact-type input apparatus 1, operation panel 3 includes operation portion 3a1 and non-operation portion 3a3 on front surface 3a; vibration actuator 2 is disposed in first portion 3b1 on back surface 3b—first portion 3b1 corresponding to operation portion 3a1); and frame 4 that fixes operation panel 3 is disposed in second portion 3b3 on back surface 3b—second portion 3b3 corresponding to a boundary portion between operation portion 3a1 and non-operation portion 3a3. With this configuration, in operation panel 3, high-output vibration can be obtained to operation portion 3a1 and vibration transmission to non-operation portion 3a3 can be suppressed. That is, it is possible provide necessary tactile feedback to a finger operating operation portion 3a1 while suppressing unnecessary tactile feedback to a finger touching a region (non-operation portion 3a3) which is configured to not receive a contact operation input. It is possible to impart an excellent operation tactile sensation to the operator.

In addition, vibration actuator 2 mounted on contact-type input apparatus 1 includes the following: base part 30 which is disposed parallel to operation panel 3; the electromagnet which is disposed to face base part 30 in the surface orthogonal direction and in which coil 22 is wound around a central portion of core 24; and elastically deformable plate-shaped elastic part 40 which supports the electromagnet (coil 22 and core 24) and is connected to base part 30. One of the electromagnet (coil 22 and core 24) and base part 30 is displaced in one direction in the surface orthogonal direction toward the other one of the electromagnet (coil 22 and core 24) and base part 30 by the magnetic force of the electromagnet (coil 22 and core 24) generated by energizing coil 22, and vibrates in both directions in the surface orthogonal direction by the elastic force of plate-shaped elastic part 40 generated by the elastic deformation of plate-shaped elastic part 40. With such a configuration of the electromagnetic vibration actuator 2 that vibrates in the surface orthogonal direction, it is possible to impart a necessary tactile sensation with higher output.

### Embodiment 2

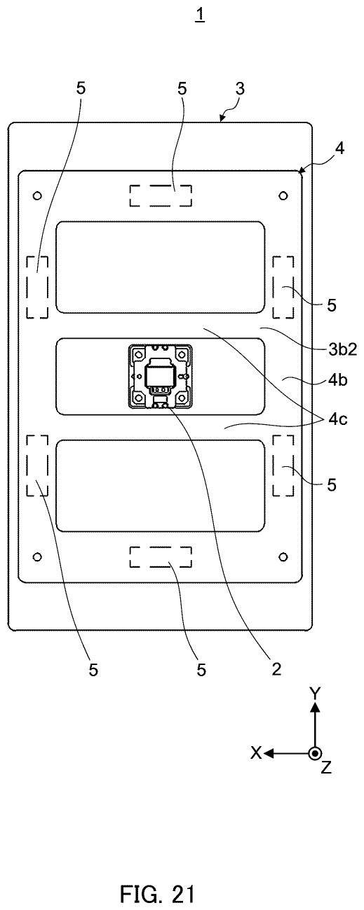

Hereinafter, Embodiment 2 of the present invention will be described. The present embodiment is basically the same as Embodiment 1. Therefore, the same reference numerals as those in Embodiment 1 are given to the components common with Embodiment 1 in the present embodiment, and detailed descriptions thereof will be omitted. The present embodiment is different from Embodiment 1 in that only one vibration actuator 2 is disposed on the central portion in the first region 3a1 of contact-type input apparatus 1 (see FIG. 21). Even in this configuration, the effects described in Embodiment 1 can be realized, and the effects can be realized at a low cost by minimizing the number of the vibration actuators 2 disposed.

### Embodiment 3

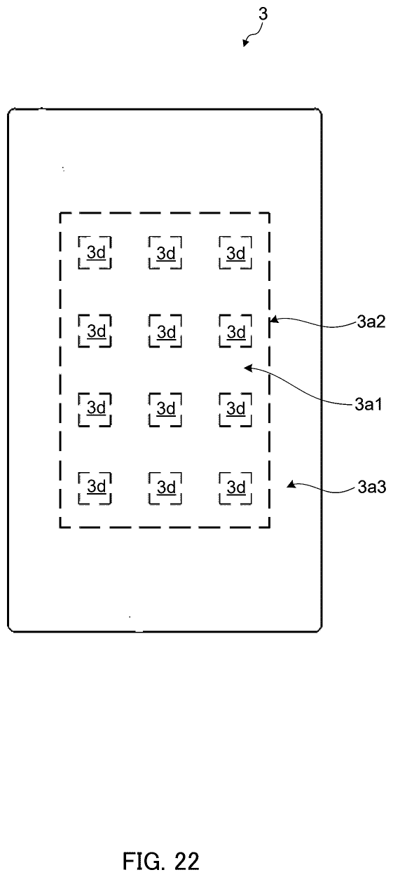

Hereinafter, Embodiment 3 of the present invention will be described. The present embodiment is basically the same as Embodiment 1. Therefore, the same reference numerals as those in Embodiment 1 are given to the components common with Embodiment 1 in the present embodiment, and detailed descriptions thereof will be omitted. The present embodiment is different from Embodiment 1 in that, in operation panel 3, a load sensor capable of detecting a load of the contact operation is provided in addition to position sensor 3c capable of detecting the position of the contact operation. In the present embodiment, position sensor 3c and the load sensor are collectively referred to as a “position load sensor 3d”. As illustrated in FIG. 22, the disposition positions of position load sensors 3d are the same as the disposition positions of position sensors 3c described in Embodiment 1.

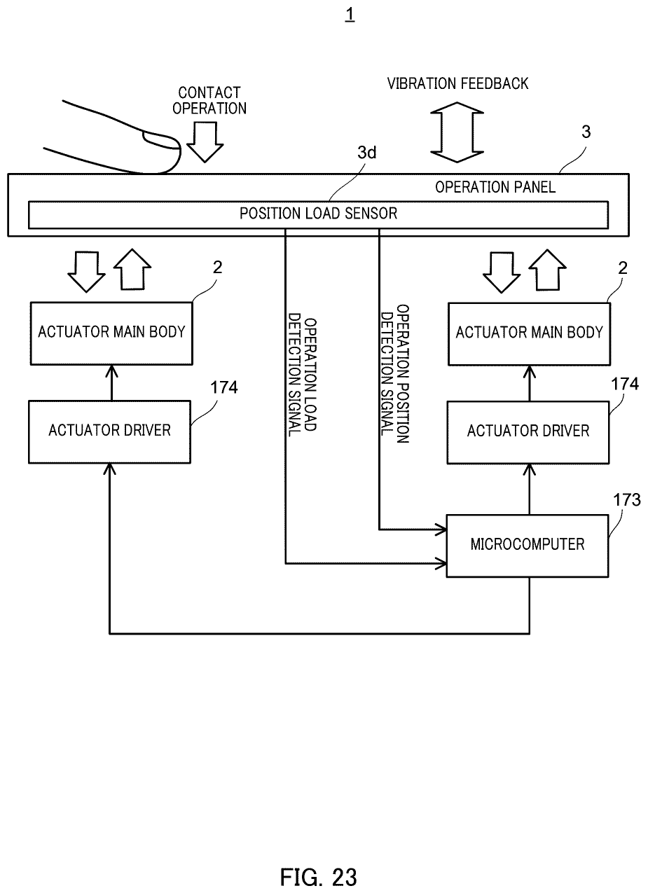

FIG. 23 schematically illustrates a control system of contact-type input apparatus 1 according to the present embodiment.

The control system of contact-type input apparatus 1 illustrated in FIG. 23 includes two actuators 2, operation panel 3, microcomputer 173, and two actuator drivers 174.

Operation panel 3 receives a contact operation from an operator on operation panel 3, and outputs to microcomputer 173 a signal (operation position detection signal) indicating the contact position of the contact operation and a signal (operation load detection signal) indicating the operation load of the contact operation from position load sensor 3d.

Microcomputer 173 controls one or both of actuator drivers 174 based on the operation position detection signal and the operation load detection signal so that vibration occurs at a position and intensity corresponding to the contact operation. Actuator driver 174 controlled by microcomputer 173 supplies a drive current as an actuator drive signal to coil 22 of the corresponding actuator 2.

Actuator 2 that has received the drive current from actuator driver 174 transmits vibration to operation panel 3 to vibrate operation panel 3, thereby imparting a tactile sensation to the operator who has operated operation panel 3. As described above, by energizing coil 22 of an appropriate actuator 2 according to the position and the load detected by position load sensor 3d and applying vibration to operation panel 3 at an appropriate position and intensity, a more realistic tactile sensation can be realized. In addition, since the appropriate actuator 2 can be selectively driven in consideration of not only the detection result of the position of the contact operation but also the detection result of the load of the contact operation, it is possible to suppress the malfunction of actuator 2 and to improve the movement accuracy.

### Embodiment 4

Hereinafter, Embodiment 4 of the present invention will be described. The present embodiment is basically the same as Embodiment 1. Therefore, the same reference numerals as those in Embodiment 1 are given to the components common with Embodiment 1 in the present embodiment, and detailed descriptions thereof will be omitted. The present embodiment is different from Embodiment 1 in that load sensor 4d is provided on frame 4, and in that the shape of frame 4 at a position where load sensor 4d is disposed is different. Therefore, in the description of the present embodiment, differences from Embodiment 1 will be mainly described.

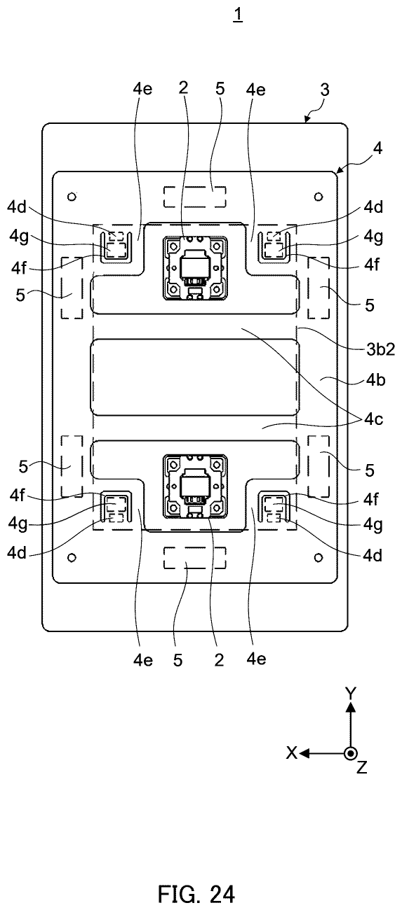

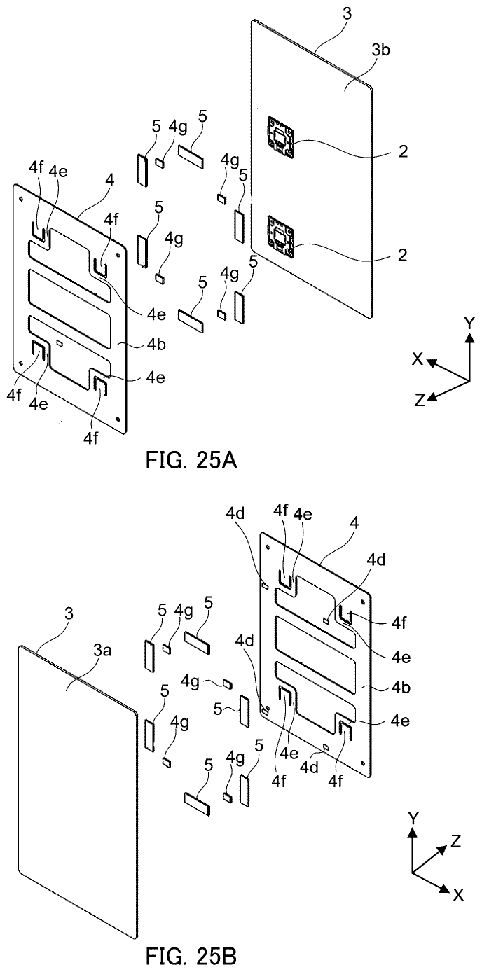

As illustrated in FIGS. 24, 25A, and 25B, in contact-type input apparatus 1 according to the present embodiment, frame 4 includes protruding portions 4e that respectively protrude inward at the four corners of outer peripheral portion 4b. A C-shaped slit is formed in each protruding portion 4e. In other words, the protruding portion has a configuration such that tongue-shaped piece 4f defined by the slit is connected to outer peripheral portion 4b in a cantilevered state. Therefore, when tongue-shaped piece 4f of frame 4 receives a pressing force, frame 4 can cause local distortion in a portion where tongue-shaped piece 4f is connected to outer peripheral portion 4b. In addition, tongue-shaped piece 4f supports load sensor 4d in the portion where tongue-shaped piece 4f is connected to outer peripheral portion 4b.

As described above, frame 4 includes protruding portion 4e that protrudes from second portion 3b3 toward first portion 3b1, and protruding portion 4e supports, in a cantilevered state, load sensor 4d that detects the load of the contact operation. Therefore, it is possible to realize a configuration capable of detecting the load of the contact operation without performing too complicated processing on frame 4 and to improve the movement accuracy such as described in Embodiment 3. It is preferable that spacer 4g is disposed between tongue-shaped piece 4f and back surface 3b of operation panel 3 so that the load of the contact operation applied to operation panel 3 is reliably transmitted to tongue-shaped piece 4f.

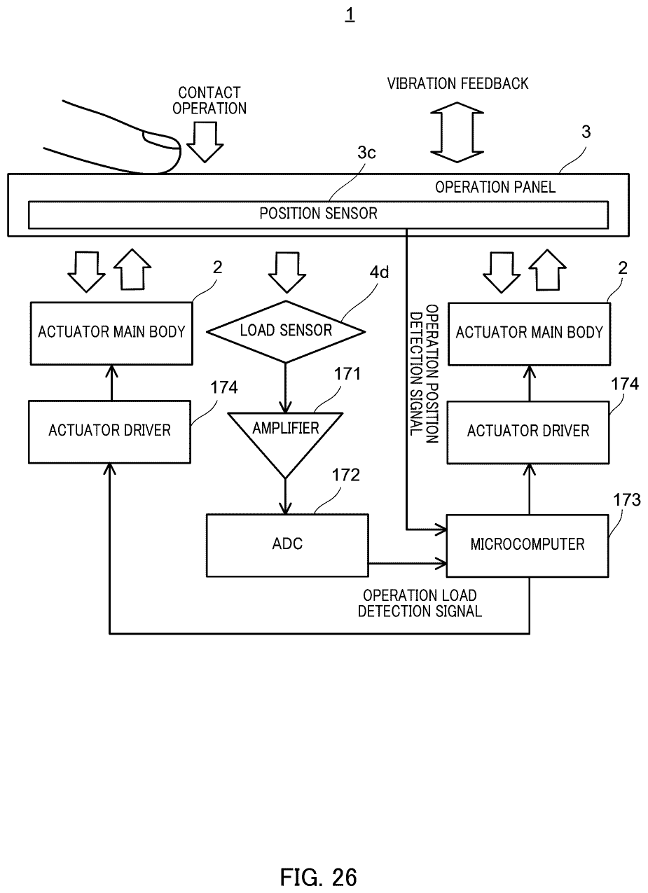

FIG. 26 schematically illustrates a control system of contact-type input apparatus 1 according to the present embodiment.

The control system of contact-type input apparatus 1 illustrated in FIG. 26 includes a plurality of load sensors 4d in addition to two actuators 2, operation panel 3, microcomputer 173, two actuator drivers 174, amplifier 171, and ADC 172. Amplifier 171 and ADC 172 are provided corresponding to each of individual load sensors 4d, but in FIG. 26, only one load sensor 4d, one amplifier 171, and one ADC 172 are illustrated for simplicity.

Operation panel 3 receives the contact operation input from an operator on operation panel 3, and outputs a signal (operation position detection signal) indicating the contact position of the contact operation from position sensor 3c to the microcomputer. In addition, load sensor 4d outputs a signal (operation load detection signal) indicating the operation load of the contact operation to microcomputer 173 via amplifier 171 and ADC 172.

Microcomputer 173 controls one or both of actuator drivers 174 in such a way that vibration occurs at a position and intensity corresponding to the contact operation, based on the operation position detection signal and the operation load detection signal. Actuator driver 174 controlled by microcomputer 173 supplies a drive current as an actuator drive signal to coil 22 of the corresponding actuator 2.

Actuator 2 that has received the drive current from actuator driver 174 transmits vibration to operation panel 3 to vibrate operation panel 3, thereby imparting a tactile sensation to the operator who has operated operation panel 3. As described above, by energizing coil 22 of an appropriate actuator 2 according to the position and the load detected by position sensor 3c and load sensor 4d and applying vibration to operation panel 3 at an appropriate position and intensity, a still more realistic tactile sensation can be realized. In addition, since an appropriate actuator 2 can be selectively driven in consideration of not only the detection result of the position of the contact operation but also the detection result of the load, it is possible to suppress a malfunction of actuator 2 and to improve the movement accuracy.

### Embodiment 5

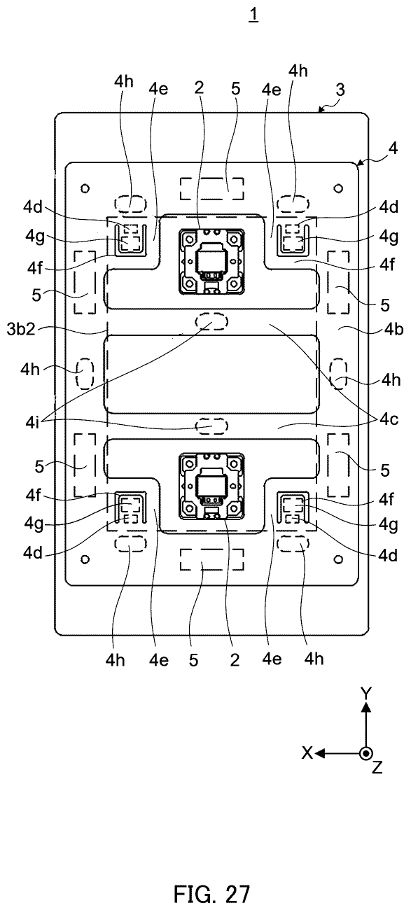

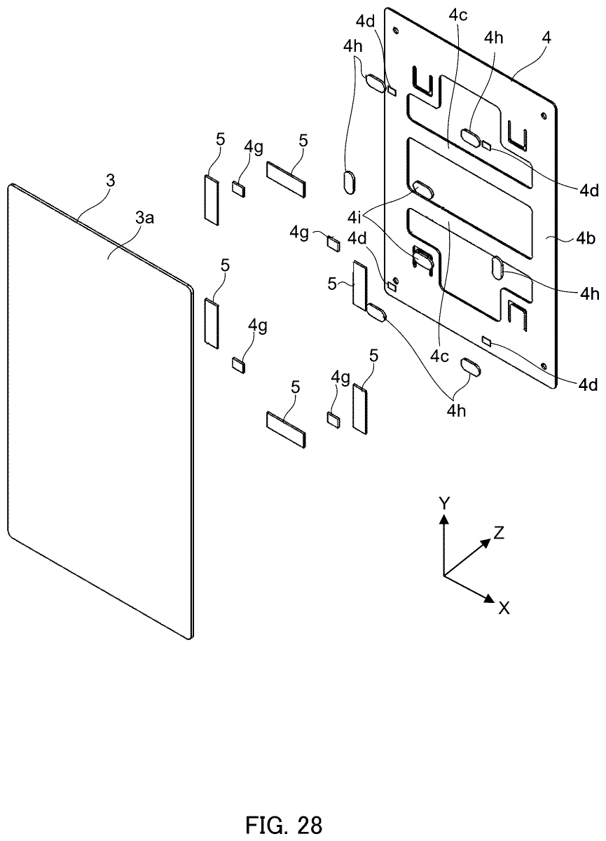

Hereinafter, Embodiment 5 of the present invention will be described. The present embodiment is basically the same as Embodiment 4. Therefore, the same reference numerals as those in Embodiments 1 and 4 are given to the components common with Embodiments 1 and 4 in the present embodiment, and detailed descriptions thereof will be omitted. The present embodiment is different from Embodiment 4 in the following points: damping material 4h is provided between outer peripheral portion 4b of frame 4 and operation panel 3; and damping material 4i is also provided between central portion 4c of frame 4 and operation panel 3 (see FIGS. 27 and 28).

Depending on the material of operation panel 3, such as its rigidity, it may be possible that frame 4 alone is not enough to sufficiently suppress the transmission of vibrations to non-operation portion 3a3. On the other hand, in the present embodiment, by disposing damping material 4h on outer peripheral portion 4b, the vibration can be appropriately damped even when the vibration is transmitted to non-operation portion 3a3, so that the vibration reverberation is satisfactorily suppressed, and it is possible to provide excellent operation tactile sensation.

In addition, in the present embodiment, damping material 4i is provided in central portion 4c of frame 4. Depending on the fixing state between frame 4 and operation panel 3, i may be possible that a degree to which frame 4 blocks the transmission of vibrations may become uneven, resulting in different tactile sensations depending on the operation position. On the other hand, in the present embodiment, by disposing damping material 4i on central portion 4c, the vibration near the center, which is the easiest position to move, can be damped, and thus a difference between the tactile sensation provided at the easy-to-move position and the tactile sensation obtained at the difficult-to-move position can be reduced, thereby suppressing unevenness in the tactile sensation.

The unevenness in the tactile sensation can be suppressed by adjusting the drive current value according to the position of the contact operation, but the adjustment range of the drive current can be narrowed by disposing damping material 4i on central portion 4c as in the present embodiment, so that the suppression of the unevenness in the tactile sensation can be easily realized.

The configuration of contact-type input apparatus 1 according to the present embodiment includes the configuration described in Embodiment 4, but the damping materials 4h and 4i can be added to the configuration of Embodiment 1 even when the configuration of Embodiment 4 is not adopted.

Although the embodiments of the present invention has been described in detail, the present invention is not limited to the specific embodiment described above. Various changes and modifications can be made to the specific examples described in the above embodiment within the scope of the gist of the present invention described in the claims.

The disclosure contents of the specification, the drawings, and the abstract included in Japanese Patent Application No. 2023-074842 filed on Apr. 28, 2023 are incorporated in the present application.

### Industrial Applicability

The contact-type input apparatus according to the embodiment of the present invention can be suitably used in an input device having a planar operation portion, such as a track pad.

### Reference Signs List

1 Contact-type input apparatus
2 Vibration actuator
3 Operation panel
3a Front surface
3a1 Operation portion
3a2, 3b2, 3b4 Outer edge portion
3a3 Non-operation portion
3b Back surface
3b1 First portion
3b3 Second portion
3b5 Third portion
3c Position sensor
3d Position load sensor
4 Frame
4a Through hole
4b Outer peripheral portion
4c Central portion
4d Load sensor
4e Protruding portion
4f Tongue-shaped piece
4g Spacer
4h, 4i Damping material
5 Joining member
152 Switching element
154 Signal generation part
171 Amplifier
172 ADC
173 Microcomputer
174 Actuator driver
DR1, DR2, DR3, DR4 Divided region

1. A contact-type input apparatus comprising:
an operation panel; and
a vibration actuator disposed on a back surface of the operation panel, wherein the contact-type input apparatus is configured to impart a tactile sensation to an operator by vibrating the vibration actuator in a surface orthogonal direction according to a contact operation on the operation panel,
the operation panel includes an operation portion and a non-operation portion on a front surface of the operation panel,
the vibration actuator is disposed in a first portion on the back surface, the first portion corresponding to the operation portion, and
a fixing tool that fixes the operation panel is disposed in a second portion on the back surface, the second portion corresponding to a boundary portion between the operation portion and the non-operation portion.

2. The contact-type input apparatus according to claim 1, wherein
the fixing tool is disposed in the second portion and includes a frame that has a shape surrounding an entire periphery of the first portion.

3. The contact-type input apparatus according to claim 1, wherein:
the vibration actuator includes
a magnetic body disposed parallel to the operation panel,
an electromagnet that includes a core and a coil wound around a central portion of the core, the electromagnet being disposed to face the magnetic body in the surface orthogonal direction, and
an elastic body that supports the electromagnet, is connected to the magnetic body, and is elastically deformable; and
one of the electromagnet and the magnetic body is displaced in one direction in the surface orthogonal direction toward another one of the electromagnet and the magnetic body by a magnetic force of the electromagnet generated by energizing the coil, and
the one of the electromagnet and the magnetic body vibrates in both directions in the surface orthogonal direction by an elastic force of the elastic body generated by an elastic deformation of the elastic body.

4. The contact-type input apparatus according to claim 3, wherein:
the magnetic body is flat plate shaped such that a plate surface of the magnetic body is disposed parallel to the operation panel; and
the magnetic body includes an opening that allows the electromagnet and the magnetic body to move relative to each other while the coil is disposed inside the opening during vibration.

5. The contact-type input apparatus according to claim 3, wherein:
the magnetic body, the electromagnet, and the elastic body are flat plate shaped such that a plate surface of each of the magnetic body, the electromagnet, and the elastic body is disposed parallel to the operation panel; and
when one of the electromagnet and the magnetic body is at a neutral position in the surface orthogonal direction, the elastic body is entirely located in a gap between the magnetic body and the electromagnet in the surface orthogonal direction.

6. The contact-type input apparatus according to claim 5, wherein
the elastic body has a rectangular frame shape surrounding the magnetic body and the electromagnet, supports the electromagnet on a pair of opposite sides of the elastic body, and is connected to the magnetic body on another pair of opposite sides of the elastic body.

7. The contact-type input apparatus according to claim 1, wherein
the vibration actuator is disposed at one location in a central portion of the first portion.

8. The contact-type input apparatus according to claim 1, wherein
a plurality of the vibration actuators are disposed at a plurality of locations in the first portion.

9. The contact-type input apparatus according to claim 8, wherein
the plurality of locations are two locations corresponding to regions at both ends among four regions obtained by dividing the first portion into four equal parts in a longitudinal direction of the first portion.

10. The contact-type input apparatus according to claim 8, further comprising:
a position sensor that detects a position of the contact operation and a load sensor that detects a load of the contact operation; and
a controller that selectively drives a vibration actuator of the plurality of vibration actuators at the plurality of locations based on a detection result of the position and a detection result of the load.

11. The contact-type input apparatus according to claim 2, wherein:
the fixing tool includes a protruding portion that protrudes from the second portion toward the first portion in the frame; and
the protruding portion supports a load sensor in a cantilevered state, the load sensor detecting a load of the contact operation.

12. The contact-type input apparatus according to claim 2, further comprising:
a damping material disposed between an outer peripheral portion of the frame and the operation panel.

13. The contact-type input apparatus according to claim 2, wherein:
the frame includes a central portion that extends through a center of the first portion; and
the contact-type input apparatus further comprises a damping material that is disposed between the central portion of the frame and the operation panel.
